(19) United States
(12) Patent Application Publication
(10) Pub. No.: US 2020/0327484 A1
(43) Pub. Date: Oct. 15, 2020

(54) SHARING SYSTEM

(71) Applicant: TOYOTA JIDOSHA KABUSHIKI KAISHA, Toyota-shi (JP)

(72) Inventors: Kohei OHTSUKA, Tokyo (JP); Atsushi SAJIKI, Okazaki-shi (JP); Yukio UMEMURA, Tokyo (JP); Takashi NANBU, Tokyo (JP); Hiroki TABATA, Tokyo (JP); Hiroki HAGIWARA, Tokyo (JP); Takeshi SAOTOME, Tokyo (JP)

(73) Assignee: TOYOTA JIDOSHA KABUSHIKI KAISHA, Toyota-shi (JP)

(21) Appl. No.: 16/842,044

(22) Filed: Apr. 7, 2020

(30) Foreign Application Priority Data
Apr. 12, 2019 (JP) 2019-076136

(51) Int. Cl. G06Q 10/08; B65G 1/137; G06Q 20/14

(52) U.S. Cl. CPC G06Q 10/083; G06Q 20/14; B65G 1/1371

(57) ABSTRACT

A sharing system includes a management apparatus connected to a plurality of user terminals, a storage facility terminal provided in a storage facility, and a plurality of relay facility terminals respectively provided in a plurality of relay facilities through a network. The management apparatus includes a usage processing unit configured to perform usage processing of an article. When the usage processing unit receives a usage request, which is transmitted from the user terminal and which includes a usage user and a usage article, the usage processing unit transmits, to the storage facility terminal, a transport instruction to transport the usage article to the relay facility corresponding to the usage user, as the usage processing.

### TECHNICAL FIELD

An aspect of the present disclosure relates to a sharing system for sharing an article with a plurality of users.

### CROSS-REFERENCE TO RELATED APPLICATION

This application claims the benefit of priority from Japanese Patent Application No. 2019-076136, filed Apr. 12, 2019, the entire contents of which are incorporated herein by reference.

### BACKGROUND

Japanese Unexamined Patent Publication No. 2016-018528 discloses a product sharing system in which a plurality of users jointly purchase tickets.

### SUMMARY

In a sharing system disclosed in Japanese Unexamined Patent Publication No. 2016-018528, a plurality of users jointly purchase identical products, and thus the respective users should store the jointly purchased products at home or the like. Therefore, when the number of products to be jointly purchased increases, it becomes difficult for the respective users to store the jointly purchased products at home or the like.

Here, an aspect of the present disclosure has an object to provide a sharing system for enabling an article to be shared with the plurality of users.

According to an aspect to the present disclosure, there is provided a sharing system in which a storage facility for storing an article and a plurality of relay facilities are provided on a circulation route of a vehicle to share the article with a plurality of users, including a management apparatus connected to a plurality of user terminals, a storage facility terminal provided in the storage facility, and a plurality of relay facility terminals respectively provided in the plurality of relay facilities through a network, in which the management apparatus includes a usage processing unit configured to perform usage processing of the article, and in which, when the usage processing unit receives a usage request, which is transmitted from the user terminal and which includes a usage user and a usage article, the usage processing unit transmits, to the storage facility terminal, a transport instruction to transport the usage article to the relay facility corresponding to the usage user, as the usage processing.

In the sharing system, when the usage processing unit receives the usage request transmitted from the user terminal, the usage processing unit transmits the transport instruction to transport the usage article to the relay facility corresponding to the usage user to the storage facility terminal. Then, in the storage facility, it is possible to cause the vehicle circulating on the circulation route to transport the usage article to the relay facility corresponding to the usage user based on the transport instruction. Therefore, the usage article is transported from the storage facility to the relay facility corresponding to the usage user, and thus it is possible for the user to use the article in such a way that the usage user goes to the relay facility to fetch the usage article or the vehicle, which performs collection and delivery under jurisdiction of the relay facility, delivers the usage article to the usage user. Therefore, it is possible to share the article with a plurality of users.

The management apparatus may further include a return processing unit configured to perform return processing of the article, and, when the return processing unit receives a return request, which is transmitted from the user terminal and which includes a return user and a return article, the return processing unit may transmit, to the relay facility terminal corresponding to the return user, a transport instruction to transport the return article to the storage facility, as the return processing. In the sharing system, when the return processing unit receives the return request, which is transmitted from the user terminal, the return processing unit transmits the transport instruction to transport the return article to the storage facility, to the relay facility terminal corresponding to the return user. Then, in the relay facility corresponding to the return user, it is possible to cause the vehicle circulating on the circulation route to transport the return article to the storage facility based on the transport instruction. Therefore, the return article is transported from the relay facility corresponding to the return user to the storage facility, and thus it is possible for the return user to return the article in such a way that, for example, the return user brings the return article to the relay facility or the vehicle, which performs collection and delivery under the jurisdiction of the relay facility, collects the return article.

The management apparatus may further include a payment processing unit configured to perform payment processing, and, when the usage processing unit performs the usage processing, the payment processing unit may perform payment for a usage fee of the usage article using a payment method associated with the usage user, as the payment processing. In the sharing system, when the usage processing unit performs the usage processing, the payment processing unit performs the payment for the usage fee of the usage article using the payment method associated with the usage user, and thus it is possible to appropriately perform the payment for the usage fee associated with use of the article. Therefore, the sharing system becomes a system that is advantageous to an owner of the article.

The payment processing unit may perform the payment for a storage fee using a payment method associated with the owner of the article, as the payment processing. In the sharing system, the payment processing unit performs the payment for the storage fee using the payment method associated with the owner of the article, and thus it is possible to appropriately perform the payment for the storage fee associated with storage of the article. Therefore, the sharing system becomes a system that is advantageous to the owner of the storage facility.

The sharing system may further include a user management database in which the user is associated with the relay facility. In the sharing system, the user is associated with the relay facility in the user management database, and thus it is possible to rapidly and appropriately determine the relay facility corresponding to the user.

In the user management database, the user may be associated with the payment method. In the sharing system, the user is associated with the payment method in the user management database, and thus it is possible to quickly and appropriately determine the payment method for each user.

The sharing system may further include an article management database in which the article is associated with availability information. In the sharing system, the article is associated with the availability information in the article management database, and thus it is possible to rapidly and appropriately determine whether or not the article is available.

In the article management database, the article may be also associated with the usage fee. In the sharing system, the article is associated with the usage fee in the article management database, and thus it is possible to appropriately perform the payment for the usage fee associated with the use of the article.

In the article management database, the article may be also associated with the owner and the storage fee. In the sharing system, the article is associated with the owner and the storage fee in the article management database, and thus it is possible to appropriately perform the payment for the storage fee associated with the storage of the article.

According to an aspect of the present disclosure, it is possible to share an article with a plurality of users.

### BRIEF DESCRIPTION OF THE DRAWINGS

FIG. 1 is a schematic diagram illustrating a sharing service using a sharing system according to an embodiment.

FIG. 2 is a schematic diagram illustrating the sharing system.

FIG. 3 is a diagram illustrating an example of a user management database.

FIG. 4 is a diagram illustrating an example of an article management database.

FIG. 5 is a block diagram illustrating a functional configuration of a management apparatus.

FIG. 6 is a flowchart illustrating a flow of article usage processing.

FIG. 7 is a flowchart illustrating a flow of article return processing.

### DETAILED DESCRIPTION

Hereinafter, an embodiment of the present disclosure will be described in detail with reference to the accompanying drawings. Note that, in the description below, the same or equivalent elements will be denoted by the same reference symbols, and description thereof will not be repeated.

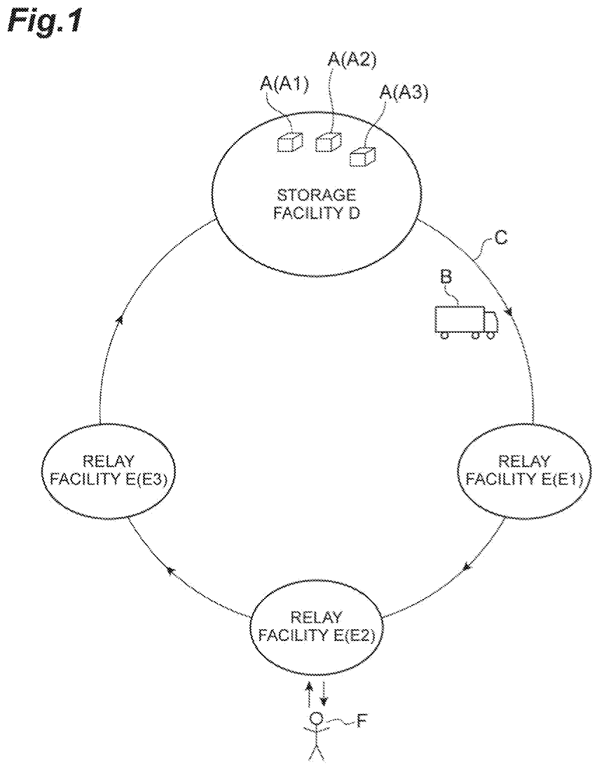

First, a sharing service using a sharing system according to the present embodiment will be described with reference to FIG. 1. As illustrated in FIG. 1, the sharing system according to the present embodiment is a system for sharing an article A with a plurality of users.

In the sharing system, a storage facility D and a plurality of relay facilities E are provided along a circulation route C of a vehicle B such as a truck. In the drawing, an example is illustrated in which three relay facilities E1 to E3 are provided along the circulation route C of the vehicle B. The storage facility D is a facility for storing the article A to be shared. As the storage facility D, for example, a storage-type warehouse such as a Distribution Center (DC), a store such as a convenience store, a personal warehouse, and the like are used. In the drawing, an example is illustrated in which three articles A1 to A3 are stored in the storage facility D. The article A may be a property of any user or a property of other than the user. The relay facility E is a facility which has jurisdiction over an address or a residence of any user, and enables the vehicle B traveling along the circulation route C to load or unload the articles A. As the relay facility E, for example, a through-type warehouse such as a Transfer Center (TC), the store such as the convenience store, and the personal warehouse, and the like are used.

When a user F uses the article A1 stored in the storage facility D, the article A1 is loaded on the vehicle B in the storage facility D, and the article A1 is unloaded from the vehicle B in the relay facility E2 which manages the address or residence of the user F. Further, the user F goes to the relay facility E2 to take the article A1, or a vehicle, which performs collection and delivery under the jurisdiction of the relay facility E2, delivers the article A1. Therefore, it is possible for the user F to use the article A1.

On the other hand, when the user F who is using the article A1 returns the article A1, the user F brings the article A1 to the relay facility E2 or the vehicle, which performs collection and delivery under the jurisdiction of the relay facility E2, collects the article A1. Therefore, the article A1 is sent to the relay facility E2. Further, the article A1 is loaded on the vehicle B in the relay facility E1, and the article A1 is unloaded from the vehicle B in the storage facility D. Therefore, the article A1 is stored in the storage facility D.

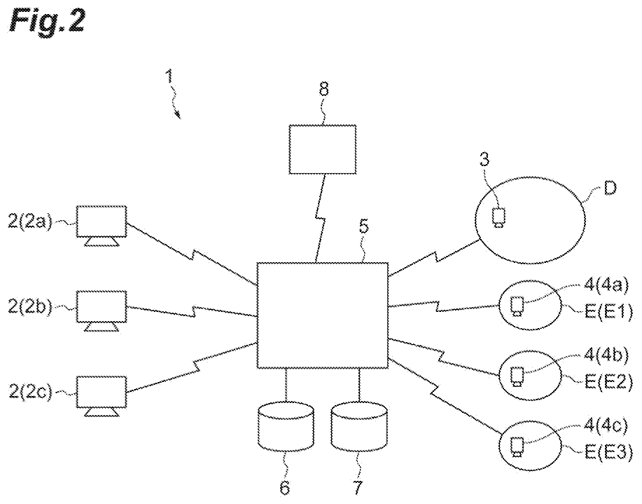

Subsequently, the sharing system 1 according to the present embodiment will be described with reference to FIG. 2. The sharing system 1 includes a plurality of user terminals 2 (2a to 2c), a storage facility terminal 3, a plurality of relay facility terminals 4 (4a to 4c), and a management apparatus 5. The drawing illustrates an example in which three user terminals 2a to 2c are provided as the plurality of user terminals 2 and three relay facility terminals 4a to 4c are provided as the plurality of relay facility terminals 4, respectively.

The user terminal 2 is a terminal operated by a user who uses a sharing service using the sharing system 1. Although the user terminal 2 is provided for each user, one user terminal 2 may be provided for a plurality of users.

The user terminal 2 is connected to the management apparatus 5 through a network such as an Internet line. The user terminal 2 sends a user registration request for performing user registration, a user correction request for correcting registered user information, and a storage request for storing the article A, a usage request for using the article A, a return request for returning the article A, and the like to the management apparatus 5 based on an operation performed by the user.

The user registration request includes, for example, information of a user to be registered. The user correction request includes, for example, information of a user to be corrected. The usage request includes, for example, information of a usage user who makes a request for usage and information of a usage article which is requested to be used. The return request includes, for example, information of a return user who makes a request for return and information of a return article which is requested to be returned. As the user terminal 2, for example, the personal computer, the smartphone, a tablet, or the like is used.

The storage facility terminal 3 is a terminal provided in the storage facility D that stores the article A. The storage facility terminal 3 is connected to the management apparatus 5 through the network such as the Internet line. As the storage facility terminal 3, for example, the personal computer, the smartphone, the tablet, or the like is used.

The relay facility terminal 4 is a terminal provided in the relay facility E. The relay facility terminal 4 is provided for each relay facility E. The relay facility terminal 4 is connected to the management apparatus 5 through the network such as the Internet line. As the relay facility terminal 4, for example, the personal computer, the smartphone, the tablet, or the like is used.

The management apparatus 5 is an electronic control unit including a Central Processing Unit (CPU), a Read Only Memory (ROM), a Random Access Memory (RAM), and the like. The management apparatus 5 executes various controls by loading a program stored in the ROM into the RAM and executing the program by the CPU. The management apparatus 5 may include a plurality of electronic control units. The management apparatus 5 may be provided in the storage facility D, may be provided in a location other than the storage facility D, or may be partially provided in the location other than the storage facility D. The management apparatus 5 may include, for example, a server.

A user management database 6 and an article management database 7 are connected to the management apparatus 5. The user management database 6 and the article management database 7 may be constructed in a storage apparatus provided in the management apparatus 5, or may be constructed in a storage apparatus provided in the management apparatus 5 through the network. In addition, the user management database 6 and the article management database 7 may be constructed in the same storage apparatus or may be constructed in different storage apparatuses.

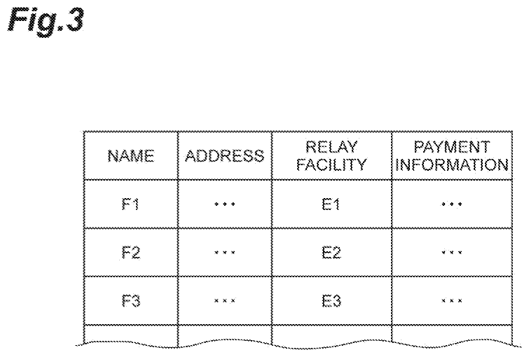

As illustrated in FIG. 3, information of the user is registered in the user management database 6. The information of the user includes, for example, “name”, “address”, “relay facility”, “payment information”, and the like. The “name” is a name of the user. The “address” is an address or residence of the user. The “relay facility” is a relay facility that has jurisdiction over the address or the residence of the user. The “payment information” is information, such as a bank account or a credit card, required for payment performed by the user.

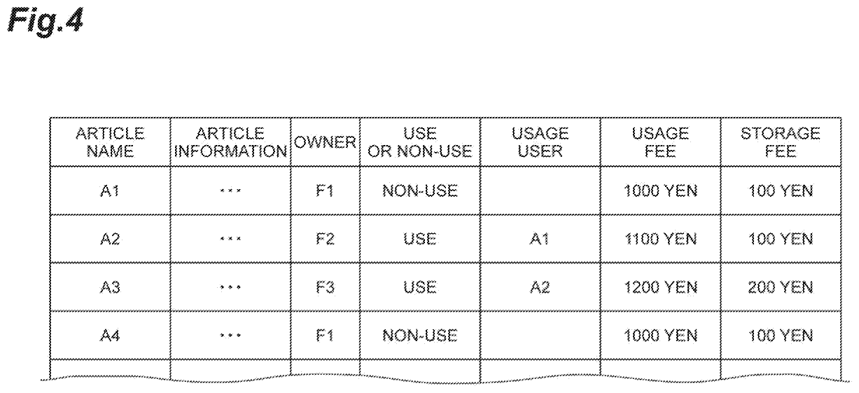

As illustrated in FIG. 4, information of the article A stored in the storage facility D is registered in the article management database 7. The information of the article A stored in the storage facility D includes, for example, “article name”, “article information”, “owner”, “use or non-use”, “usage user”, “usage fee”, “storage fee”, and the like. The “article name” is a name of the article A. The “article information” is information indicating a type, a feature, description, and the like of the article A. The “owner” is identification information of an owner of the article A, and includes, for example, a name of the owner, an identification number of the owner, and the like. The “use or non-use” is information indicating whether or not the article A is used by the user.

The “usage user” is identification information of a user who uses the article A, and includes, for example, the name of the user, an identification number of the user, and the like. The “usage fee” is a fee required for using the article A (for example, a weekly fee). The “storage fee” is a fee required for storing the article A (for example, a monthly fee).

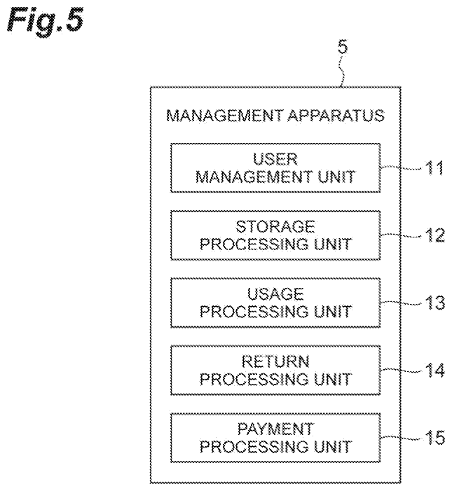

As illustrated in FIG. 5, the management apparatus 5 functionally includes a user management unit 11, a storage processing unit 12, a usage processing unit 13, a return processing unit 14, and a payment processing unit 15.

The user management unit 11 manages the user. When the user management unit 11 receives the user registration request from the user terminal 2, the user management unit 11 adds the information of the user to the user management database 6 based on the information transmitted from the user terminal 2. In addition, when the user management unit 11 receives the user correction request from the user terminal 2, the user management unit 11 corrects the information of the user, which is registered in the user management database 6, based on the information transmitted from the user terminal 2.

The storage processing unit 12 manages the article A to be stored in the storage facility D. When the storage processing unit 12 receives the storage request from the user terminal 2, the storage processing unit 12 adds the information of the article A to the article management database 7 based on the information transmitted from the user terminal 2. Here, the “storage fee” of the article management database 7 may be automatically set by the storage processing unit 12 based on, for example, a storage policy of a sharing service provider.

When the usage processing unit 13 receives the usage request, which includes the usage user and the usage article, transmitted from the user terminal 2, the usage processing unit 13 performs usage processing. The usage processing is a process for the user to use the article stored in the storage facility D. The usage processing unit 13 performs subsequent processing as the usage processing.

The usage processing unit 13 first determines whether or not the usage article is being used with reference to the article management database 7. Further, when the usage processing unit 13 determines that the usage article is being used, the usage processing unit 13 transmits information, which indicates that it is not possible to use the usage article because the usage article is being used, to the user terminal 2.

On the other hand, when the usage processing unit 13 determines that the usage article is not being used, the usage processing unit 13 updates the “use or non-use” and the “usage user” of the article management database 7. In addition, the usage processing unit 13 transmits a transport instruction to transport the usage article to the relay facility E corresponding to the usage user to the storage facility terminal 3 based on the received usage request. The transport instruction includes the information of the usage user and the relay facility E corresponding to the usage user. The information of the usage user includes, for example, the “name” and the “address” registered in the user management database 6.

On the other hand, in the storage facility D, when the storage facility terminal 3 receives the transport instruction transmitted from the usage processing unit 13, the storage facility terminal 3 causes the vehicle B circulating on the circulation route C to transport the usage article to the relay facility E corresponding to the usage user based on the transport instruction. For example, in the storage facility D, the usage article is fetched and a sending slip is attached to the usage article based on the transport instruction. The sending slip includes the information of the usage user as a sending destination and information of the relay facility E corresponding to the usage user as the relay destination. Fetching of the usage article, preparation of the sending slip, attachment of the sending slip, and the like may be performed manually or automatically performed by the storage facility terminal 3, a robot, or the like. Further, in the storage facility D, the usage article on which the sending slip is attached is loaded on the vehicle B circulating on the circulation route C.

In the relay facility E corresponding to the usage user, the usage article to which the sending slip is attached is unloaded from the vehicle B circulating on the circulation route C. Further, when the usage user goes to the relay facility E to take the usage article or the vehicle, which performs collection and delivery under the jurisdiction of the relay facility E, delivers the usage article to the usage user, the usage article is sent to the usage user.

When the return processing unit 14 receives the return request, which is transmitted from the user terminal 2 and includes the return user and the return article, the return processing unit 14 performs the return processing. The return processing is processing for returning the article used by the user to the storage facility D. The return processing unit 14 performs subsequent processing as the return processing.

The return processing unit 14 transmits the transport instruction to transport the return article to the storage facility D to the relay facility terminal 4 corresponding to the return user based on the received return request. The transport instruction includes the information of the return user and the storage facility D. The information of the return user includes, for example, the “name” and the “address” registered in the user management database 6. In addition, the return processing unit 14 updates the “use or non-use” and the “usage user” in the article management database 7.

On the other hand, in the relay facility E corresponding to the return user, the return article is sent to the relay facility E corresponding to the return user in such a way that the return user brings the return article to the relay facility E or the vehicle, which performs collection and delivery under the jurisdiction of the relay facility E, collects the return article. Further, in the relay facility E corresponding to the return user, when the relay facility terminal 4 receives the transport instruction transmitted from the return processing unit 14, the relay facility terminal 4 causes the vehicle B circulating on the circulation route C to transport the return article to the storage facility D based on the transport instruction. For example, in the relay facility E corresponding to the return user, a sending slip is attached to the usage article based on the transport instruction. The sending slip includes the information of the usage user as a sending source and information of the storage facility D as a sending destination. Preparation of the sending slip, attachment of the sending slip, and the like may be manually performed or may be automatically performed by the storage facility terminal 3 or a robot. Further, in the relay facility E, the usage article, to which the sending slip is attached is loaded on the vehicle B circulating on the circulation route C.

In the storage facility D, the return article, to which the sending slip is attached, is unloaded from the vehicle B circulating on the circulation route C. Further, the usage article is stored after separating the sending slip. Separation of the sending slip, storage of the return article, and the like may be manually performed or may be automatically performed by the storage facility terminal 3 or the robot. Note that, in the storage facility D, when the storage of the return article is completed, storage completion information may be transmitted to the management apparatus 5. In this case, after the return processing unit 14 receives the storage completion information transmitted from the storage facility terminal 3, the return processing unit 14 may update the “use or non-use” and “usage user” of the article management database 7.

The payment processing unit 15 performs payment processing. The payment processing includes payment for the usage fee associated with the use of the article and payment for the storage fee associated with the storage of the article. The payment processing unit 15 performs subsequent processing as the payment processing. A payment system 8 is connected to the management apparatus 5 through the network such as the Internet line. The payment system 8 is a system for executing the payment processing by the payment processing unit 15, and it is possible to use various known systems.

When the usage processing unit 13 performs the usage processing, the payment processing unit 15 performs payment for the usage fee of the usage article using the payment method associated with the usage user. Specifically, the payment processing unit 15 determines the usage fee of the usage article and the payment method associated with the usage user. The usage fee of the usage article is determined based on, for example, the “usage fee” in the article management database 7. The payment method associated with the user is determined, for example, based on the “payment method” of the user management database 6. Further, the payment processing unit 15 performs payment for the determined usage fee using the determined payment method by the payment system 8.

In addition, the payment processing unit 15 performs payment for the storage fee using the payment method associated with the owner of the article. Specifically, the payment processing unit 15 determines the storage fee and the payment method associated with the owner of the article. The storage fee is determined, for example, based on the “storage fee” of the article management database 7. The payment method associated with the owner of the article is determined, for example, based on the “payment method” of the user management database 6. Further, the payment processing unit 15 performs payment for the storage fee determined using the determined payment method by the payment system 8.

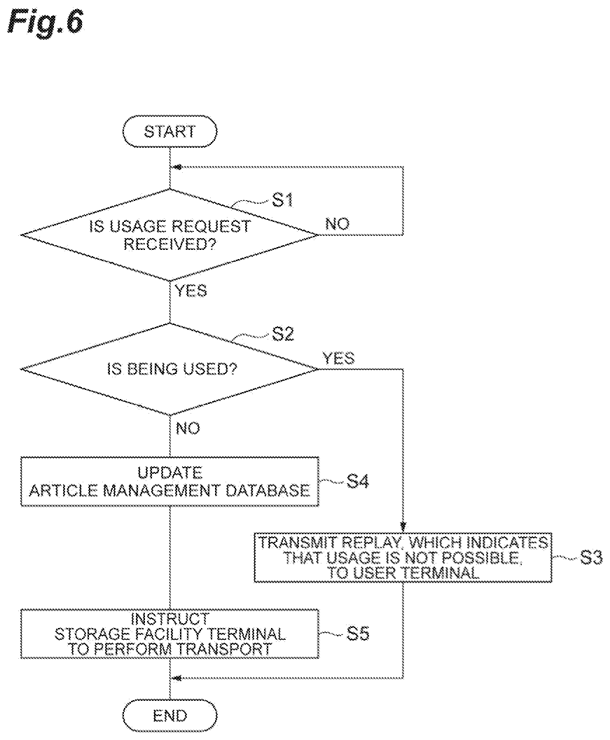

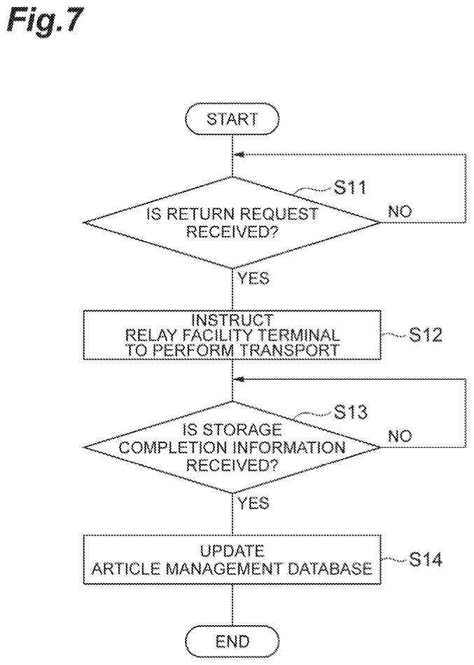

Subsequently, flows of the usage processing and the return processing of the article in the management apparatus 5 will be described with reference to FIG. 6 and FIG. 7.

As illustrated in FIG. 6, the usage processing unit 13 waits until the usage request transmitted from the user terminal 2 is received (step S1). When the usage processing unit 13 receives the usage request transmitted from the user terminal 2 (step S1: YES), the usage processing unit 13 determines whether or not the usage article is being used with reference to the article management database 7 (step S2).

When the usage processing unit 13 determines that the usage article is being used (step S2: YES), the usage processing unit 13 transmits information, which indicates that it is not possible to use the usage article because the usage article is being used, to the user terminal 2 (S3), and ends the process once. On the other hand, when the usage processing unit 13 determines that the usage article is not being used (step S2: NO), the usage processing unit 13 updates the “use or non-use” and the “usage user” of the article management database 7 (step S4). In addition, the usage processing unit 13 transmits the transport instruction to transport the usage article to the relay facility E corresponding to the usage user to the storage facility terminal 3 based on the usage request received in step S21 (step S5). Further, the usage processing unit 13 ends the process once.

As illustrated in FIG. 7, the return processing unit 14 waits until the return request transmitted from the user terminal 2 is received (step S11). When the return processing unit 14 receives the return request transmitted from the user terminal 2 (step S11: YES), the return processing unit 14 transmits the transport instruction to transport the return article to the storage facility D to the relay facility terminal 4 corresponding to the return user based on the received return request (step S12). Thereafter, the return processing unit 14 waits until the storage completion information transmitted from the relay facility terminal 4 corresponding to the return user is received (step S13).

When the return processing unit 14 receives the storage completion information transmitted from the relay facility terminal 4 corresponding to the return user (step S12: YES), the return processing unit 14 updates the “use or non-use” and the “usage user” of the article management database 7.

As described above, in the sharing system 1 according to the present embodiment, when the usage processing unit 13 receives the usage request transmitted from the user terminal 2, the usage processing unit 13 transmits the transport instruction to transport the usage article to the relay facility E corresponding to the usage user to the storage facility terminal 3. Then, in the storage facility D, it is possible to cause the vehicle B circulating on the circulation route C to transport the usage article to the relay facility E corresponding to the usage user based on the transport instruction. Therefore, the usage article is transported from the storage facility D to the relay facility E corresponding to the usage user, and thus it is possible for the usage user to use the article in such a way that, for example, the usage user goes to the relay facility E to take the usage article, or the vehicle, which performs collection and delivery under the jurisdiction of the relay facility E, delivers the usage article to the usage user. Therefore, it is possible to share the article with a plurality of users.

In addition, when the return processing unit 14 receives the return request transmitted from the user terminal, the return processing unit 14 transmits the transport instruction to transport the return article to the storage facility D to the relay facility terminal 4 corresponding to the return user. Then, in the relay facility B corresponding to the return user, it is possible to cause the vehicle B circulating on the circulation route C to transport the return article to the storage facility D based on the transport instruction. Therefore, the return article is transported from the relay facility E corresponding to the return user to the storage facility D, and thus it is possible for the return user to return the article in such a way that, for example, the return user brings the return article to the relay facility B or the vehicle, which performs collection and delivery under the jurisdiction of the relay facility E, collects the return article.

In addition, when the usage processing unit 13 performs the usage processing, the payment processing unit 15 performs the payment for the usage fee of the usage article using the payment method associated with the usage user, and thus it is possible to appropriately perform the payment for the usage fee associated with the use of the article. Therefore, the sharing system becomes a system that is advantageous to an owner of the article.

In addition, when the payment processing unit 15 performs the payment for the storage fee using the payment method associated with the owner of the article, it is possible to appropriately perform the payment for the storage fee associated with the storage of the article. Therefore, a system is provided which is advantageous to the owner of the storage facility D.

In addition, the user is associated with the relay facility E in the user management database 6, and thus it is possible to rapidly and appropriately determine the relay facility E corresponding to the user.

In addition, the user is associated with the payment method in the user management database 6, and thus it is possible to rapidly and appropriately determine the payment method for each user.

In addition, the article is associated with the availability information in the article management database 7, and thus it is possible to rapidly and appropriately determine whether or not the article is available.

Further, the article is associated with the usage fee in the article management database 7, and thus it is possible to appropriately perform payment for the usage fee associated with the usage of the article.

In addition, the article, the owner, and the storage fee are associated with each other in the article management database 7, and thus it is possible to appropriately perform payment for the storage fee associated with the storage of the article.

Hereinabove, although the embodiment of the present disclosure is described, the present disclosure is not limited to the above-described embodiment, and may be modified or applied to another matter in a scope without changing the gist disclosed in each claim. For example, a plurality of storage facilities and a plurality of storage facility terminals may be provided. In addition, for example, in the flows of the usage processing and the return processing performed on the article in the management apparatus 5, it is not essentially necessary to execute all the steps, and some of the steps may be executed simultaneously or in reverse order.

What is claimed is:

1. A sharing system, in which a storage facility for storing an article and a plurality of relay facilities are provided on a circulation route of a vehicle to share the article with a plurality of users, the sharing system comprising:
a management apparatus connected to a plurality of user terminals, a storage facility terminal provided in the storage facility, and a plurality of relay facility terminals respectively provided in the plurality of relay facilities through a network,
wherein the management apparatus includes a usage processing unit configured to perform usage processing of the article, and
wherein, when the usage processing unit receives a usage request, which is transmitted from the user terminal and which includes a usage user and a usage article, the usage processing unit transmits, to the storage facility terminal, a transport instruction to transport the usage article to the relay facility corresponding to the usage user, as the usage processing.

2. The sharing system according to claim 1,
wherein the management apparatus further includes a return processing unit configured to perform return processing of the article, and
wherein, when the return processing unit receives a return request, which is transmitted from the user terminal and which includes a return user and a return article, the return processing unit transmits, to the relay facility terminal corresponding to the return user, a transport instruction to transport the return article to the storage facility, as the return processing.

3. The sharing system according to claim 1,
wherein the management apparatus further includes a payment processing unit configured to perform payment processing, and
wherein, when the usage processing unit performs the usage processing, the payment processing unit performs payment for a usage fee of the usage article using a payment method associated with the usage user, as the payment processing.

4. The sharing system according to claim 3,
wherein the payment processing unit performs payment for a storage fee using a payment method associated with an owner of the article, as the payment processing.

5. The sharing system according to claim 1, further comprising:
a user management database in which the user is associated with the relay facility.

6. The sharing system according to claim 5,
wherein, in the user management database, the user is associated with a payment method.

7. The sharing system according to claim 1, further comprising:
an article management database in which the article is associated with availability information.

8. The sharing system according to claim 7,
wherein, in the article management database, the article is also associated with a usage fee.

9. The sharing system according to claim 7,
wherein, in the article management database, the article is also associated with an owner and a storage fee.
